(19) United States
(12) Patent Application Publication
(10) Pub. No.: US 2026/0200059 A1
(43) Pub. Date: Jul. 16, 2026

(54) ELECTRIC NAIL GUN

(71) Applicant: BASSO INDUSTRY CORP., Taichung (TW)

(72) Inventors: Jian-Rung Wu, Taichung (TW); Rui-Wen Wu, Taichung (TW); Wei-Zhe Li, Taichung (TW)

(73) Assignee: BASSO INDUSTRY CORP., Taichung (TW)

(21) Appl. No.: 19/446,032

(22) Filed: Jan. 12, 2026

(30) Foreign Application Priority Data
Jan. 15, 2025 (TW) 114200583

(51) Int. Cl. B25C 1/06; B25C 1/00

(52) U.S. Cl. CPC B25C 1/06; B25C 1/005; B25C 1/008

(57) ABSTRACT

An electric nail gun includes a gun body, a muzzle unit connected to the gun body, and defining a nail-striking channel, a magazine unit, a control unit and a safety unit. The magazine unit includes a nail magazine adapted for accommodating a plurality of nails and a magazine pusher movably mounted in the nail magazine, adapted for pushing the nails sequentially into the nail-striking channel, and having a protrusion. The control unit includes a trigger switch for outputting a start signal, a safety switch for outputting a safety signal, and a controller for initiating a striking cycle upon receipt of the start signal and the safety signal. The safety unit is movably mounted between the gun body and the muzzle unit, and includes a first safety member and a second safety member disposed between the safety switch and the first safety member, and movable between linked and delinked positions.

### CROSS-REFERENCE TO RELATED APPLICATION

This application claims priority to Taiwanese Utility Model Patent Application No. 114200583, filed on January 15, 2025, the entire disclosure of which is incorporated by reference herein.

### FIELD

The disclosure relates to a nail gun, and more particularly to an electric nail gun having a safety unit.

### BACKGROUND

Referring to FIG. 1, Taiwanese Utility Model Patent No. M427241U discloses a conventional electric nail gun 1 that includes a gun body 11 having a nail discharge opening 111, a nail magazine 12 connected to the gun body 11 and for accommodating a plurality of nails (not shown), a magazine pusher 13 movably mounted in the magazine 12 and for pushing the nails to enter the gun body 111 one by one, a switch member 14 mounted to the gun body 11, and a pivotable member 15 pivotably mounted to the nail magazine 12 and for triggering the switch member 14.

When there is no nail in the nail magazine 12, the magazine pusher 13 pushes the pivotable member 15 to pivot relative to the switch member 14 so the switch member 14 is triggered by the pivotable member 15 to output a no-nail signal indicating that there is no nail in the nail magazine 12.

### SUMMARY

Therefore, an object of the present disclosure is to provide an electric nail gun that has a safety unit and that is different from the abovementioned prior art.

According to an aspect of the disclosure, an electric nail gun includes a gun body, a muzzle unit, a magazine unit, a power unit, a control unit, and a safety unit. The muzzle unit is connected to the gun body, and defines a nail-striking channel extending along an axis. The magazine unit is connected to the muzzle unit, and includes a nail magazine and a magazine pusher. The nail magazine is adapted for accommodating a plurality of nails arranged in a row. The magazine pusher is movably mounted in the nail magazine, is adapted for pushing the plurality of nails sequentially into the nail-striking channel, and has a protrusion. The power unit is mounted to the gun body and is adapted to strike the plurality of nails in the nail-striking channel during a striking cycle. The control unit is mounted to the gun body, and includes a trigger switch, a trigger, a safety switch, and a controller. The trigger switch is configured to output a start signal when being triggered. The trigger is operable to trigger the trigger switch. The safety switch is configured to output a safety signal when being triggered. The controller is electrically connected to the trigger switch and the safety switch, and is configured to initiate the striking cycle upon receipt of the start signal and the safety signal. The safety unit is movably mounted between the gun body and the muzzle unit along the axis, and includes a first safety member and a second safety member. The first safety member is movable along the axis. The second safety member is disposed between the safety switch and the first safety member along the axis, and is movable between a linked position, where the second safety member is spaced apart from the protrusion of the magazine pusher, is co-movable with the first safety member, and triggers the safety switch when being moved toward the safety switch, and a delinked position, where the second safety member is pushed by the protrusion and is movable relative to the first safety member along the axis such that movement of the first safety member does not move the second safety member.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary sectional view of a conventional electric nail gun disclosed in Taiwanese Utility Model Patent No. M427241U.

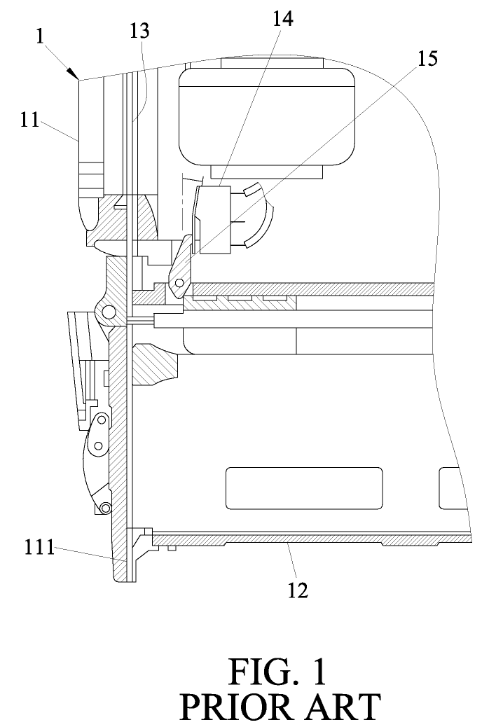

FIG. 2 is a schematic side view of an electric nail gun of a first embodiment according to the present disclosure.

FIG. 3 is a partly exploded perspective view of the first embodiment.

FIG. 4 is a fragmentary perspective view of the first embodiment.

FIG. 5 is a fragmentary side view of the first embodiment, illustrating a second safety member of the first embodiment in a linked position.

FIG. 6 is a fragmentary perspective view, illustrating an extension segment of a third safety member of the first embodiment spaced apart from a safety switch.

FIG. 7 is a fragmentary side view similar to FIG. 5, but illustrating the second safety member moving together with a first safety member of the first embodiment toward the safety switch.

FIG. 8 is a fragmentary perspective view similar to FIG. 6, but illustrating the safety switch being triggered by the extension segment.

FIG. 9 is a fragmentary side view similar to FIG. 5, but illustrating the second safety member in a delinked position.

FIG. 10 is a fragmentary side view similar to FIG. 9, but illustrating the first safety member movable relative to the second safety member.

FIG. 11 is a fragmentary sectional view of the first embodiment, illustrating the third safety member connected to a gun body of the first embodiment.

FIG. 12 is a fragmentary offset sectional view taken along line XII-XII in FIG. 5.

FIG. 13 is a fragmentary offset sectional view taken along line XIII-XIII in FIG. 9.

FIG. 14 is a fragmentary perspective view of an electric nail gun of a second embodiment according to the present disclosure.

### DETAILED DESCRIPTION

Before the disclosure is described in greater detail, it should be noted that where considered appropriate, reference numerals or terminal portions of reference numerals have been repeated among the FIGS. to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

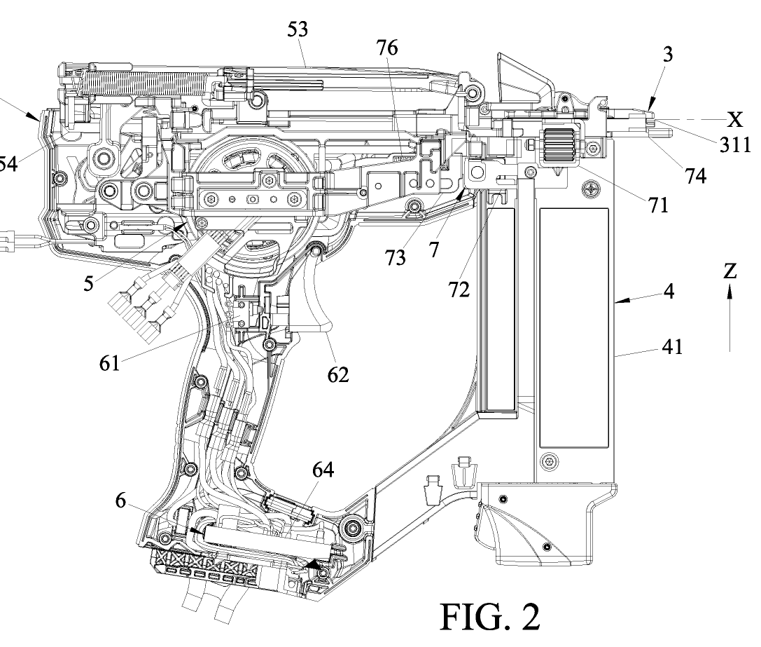

Referring to FIGS. 2 to 4, an electric nail gun of a first embodiment according to the present disclosure includes a gun body 2, a muzzle unit 3, a magazine unit 4, a power unit 5, a control unit 6, and a safety unit 7.

The muzzle unit 3 is connected to the gun body 2 and defines a nail-striking channel 31 extending along an axis (X). The nail-striking channel 31 has a nail discharge opening 311 disposed opposite to the gun body 2 along the axis (X).

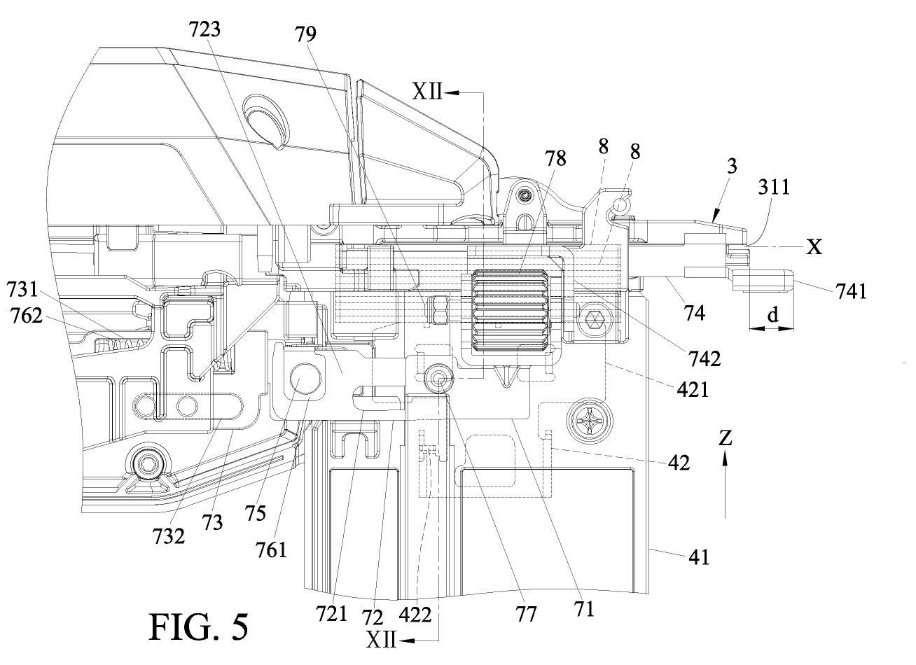

Further referring to FIG. 5, the magazine unit 4 is connected to the muzzle unit 3 and includes a nail magazine 41 and a magazine pusher 42. The nail magazine 41 is adapted for accommodating a plurality of nails 8 arranged in a row. The magazine pusher 42 is movably mounted in the nail magazine 41 and includes a pusher plate 421 and a protrusion 422. The pusher plate 421 is disposed in the nail magazine 41 and is adapted for sequentially pushing the nails 8 one by one into the nail-striking channel 31 along a feeding direction (Z) that is perpendicular to the axis (X). The protrusion 422 extends out of the nail magazine 41 toward the gun body 2.

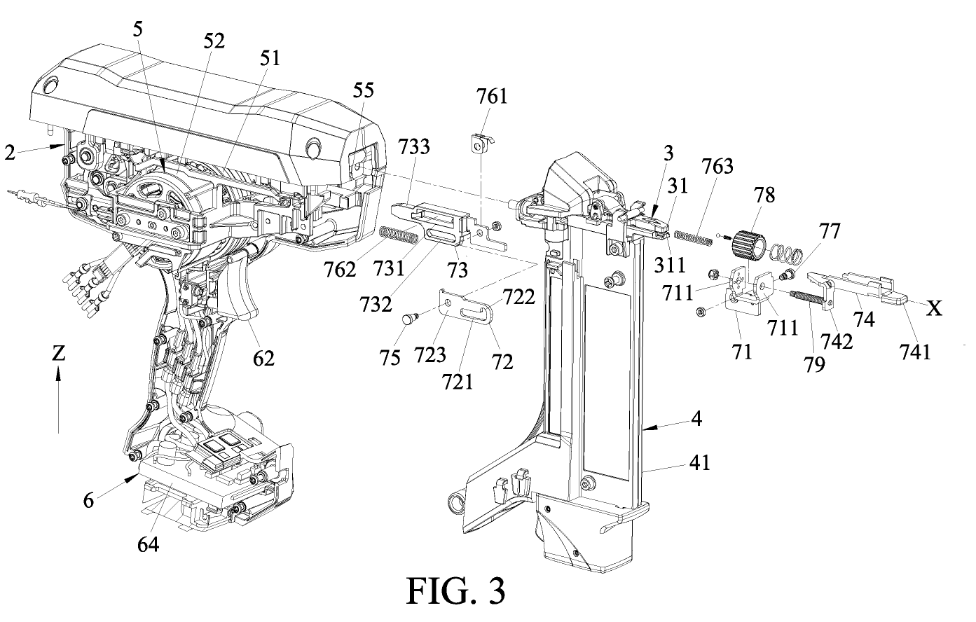

Referring to FIGS. 2, 3, and 6,, the power unit 5 is mounted to the gun body 2 and is adapted to strike the nails 8 in the nail-striking channel 31 along the axis (X) during a striking cycle, which will be described later. In this embodiment, the power unit 5 includes a flywheel 51 rotatably mounted to the gun body 2, a motor 52 for driving rotation of the flywheel 51, a pivot arm 53 connected to the gun body 2 and pivotable relative to the flywheel 51, an impact block 54 slidable along the pivot arm 53, and a nail-striking pin 55 (see FIG. 3) connected to the impact block 54 and extending into the nail-striking channel 31. When the pivot arm 53 is driven to pivot such that a distance between the flywheel 51 and the pivot arm 53 is reduced, the impact block 54 is in contact with and is actuated by the flywheel 51 to drive the nail-striking pin 55, thereby striking the nails 8 in the nail-striking channel 31 out of the nail discharge opening 311.

The control unit 6 is mounted to the gun body 2, is electrically connected to the power unit 5, and includes a trigger switch 61 configured to output a start signal when being triggered, a trigger 62 operable to trigger the trigger switch 61, a safety switch 63 configured to output a safety signal when being triggered, and a controller 64 electrically connected to the trigger switch 61 and the safety switch 63, and configured to initiate the striking cycle upon receipt of the start signal and the safety signal, for example, to drive the pivot arm 53 to pivot relative to the flywheel 51 such that the impact block 54 is actuated by the flywheel 51 to drive the nail-striking pin 55 to strike the nails 8 out of the nail discharge opening 311. In this embodiment, the controller 64 is a microcontroller or a controller such as, but not limited to, a single core processor, a multi-core processor, a dual-core mobile processor, a microprocessor, a digital signal processor (DSP), a field-programmable gate array (FPGA), an application specific integrated circuit (ASIC), a radio-frequency integrated circuit (RFIC), etc.

Referring to FIGS. 3 to 6, the safety unit 7 is movably mounted between the gun body 2 and the muzzle unit 3 along the axis (X), and includes a first safety member 71, a second safety member 72, a third safety member 73, a fourth safety member 74, a connecting pin 75, a biasing assembly 76, a slidable pin 77, an adjusting member 78, and a connector 79.

The first safety member 71 is movable along the axis (X), is mounted to one side of the nail magazine 41 opposite to the protrusion 422 in the feeding direction (Z), and has two lugs 711 spaced apart from each other along the axis (X).

The second safety member 72 is disposed between the safety switch 63 and the first safety member 71 along the axis (X), and has a main body 723 defining a sliding slot 721 and an engaging slot 722. The sliding slot 721 extends along the axis (X). The engaging slot 722 is in spatial communication with the sliding slot 721, and extends from one end of the sliding slot 721 that is adjacent to the nail discharge opening 311 in the feeding direction (Z).

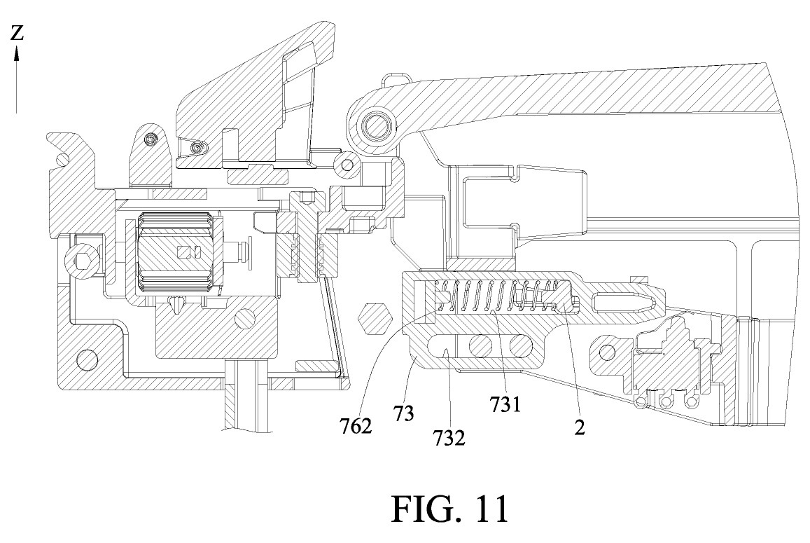

The third safety member 73 is disposed between the second safety member 72 and the safety switch 63 along the axis (X), is connected to the second safety member 72 through the connecting pin 75, and is co-movable therewith when the second safety member 72 moves along the axis (X). In this embodiment, as shown in FIG. 11, the third safety member 73 has a groove 731 extending substantially along the axis (X) and slidably engaging a block of the gun body 2, a rail groove 732 parallel to the groove 731 and slidably engaging two pillars of the gun body 2, and an extension segment 733 extending along the axis (X) towards the safety switch 63, and triggers the safety switch 63 to output the start signal when the second safety member 72 is moved toward the safety switch 63. It should be noted that engagement among the rail groove 732 and the two pillars of the gun body 2 is for guiding movement of the gun body 2 relative to the third safety member 73 along the axis (X).

The fourth safety member 74 is mounted to the muzzle unit 3, is movable relative to the muzzle unit 3 along the axis (X), and has an abutment end 741 extending away from and spaced apart from the nail discharge opening 311 along the axis (X) by a distance (d), and a connecting plate 742 opposite to the abutment end 741 along the axis (X). In this embodiment, the fourth safety member 74 serves as a nosepiece of the electric nail gun.

The connecting pin 75 is pivotably connected to the second safety member 72 and the third safety member 73, such that the second safety member 72 is pivotable about the connecting pin 75 relative to the third safety member 73.

Referring to FIGS. 2 to 5, the biasing assembly 76 includes a first biasing member 761, a second biasing member 762, and a third biasing member 763.

The first biasing member 761 is mounted above the second safety member 72 in the feeding direction (Z) and biases the second safety member 72 to pivot in a direction opposite to the feeding direction (Z). In this embodiment, the first biasing member 761 includes a leaf spring for biasing the second safety member 72 downwardly as depicted in FIG. 3, but the present disclosure is not limited herein.

The second biasing member 762 is disposed in the groove 731 and has two opposite ends abutting respectively against the block of the gun body 2 and the third safety member 73 (see FIG. 11), and biases the third safety member 73 to move away from the safety switch 63 along the axis (X).

The third biasing member 763 is mounted between the fourth safety member 74 and the gun body 2, and biases the fourth safety member 74 to move away from the gun body 2 along the axis (X). In this embodiment, the second biasing member 762 and the third biasing member 763 are compression springs, but the present disclosure is not limited herein.

The slidable pin 77 is connected to the first safety member 71 and extends through the second safety member 72 to engage either one of the sliding slot 721 or the engaging slot 722 of the second safety member 72. In this embodiment, the slidable pin 77 extends through and is connected fixedly to the first safety member 71.

The adjusting member 78 is rotatably mounted between the lugs 711 of the first safety member 71.

The connector 79 is connected fixedly to the connecting plate 742 of the fourth safety member 74, extends into the first safety member 71, and threadedly engages the adjusting member 78. In this embodiment, the connector 79 is an externally threaded rod, extends through the lugs 711 of the first safety member 71, and is co-movable with the fourth safety member 74 relative to the first safety member 71 along the axis (X) when the adjusting member 78 is rotated, such that the distance (d) between the nail discharge opening 311 and the abutment end 741 is adjusted. In this embodiment, the adjusting member 78 has an internal threaded portion threadedly engaging the connector 79 so rotation of the adjusting member 78 drives movement of the connector 79 along the axis (X).

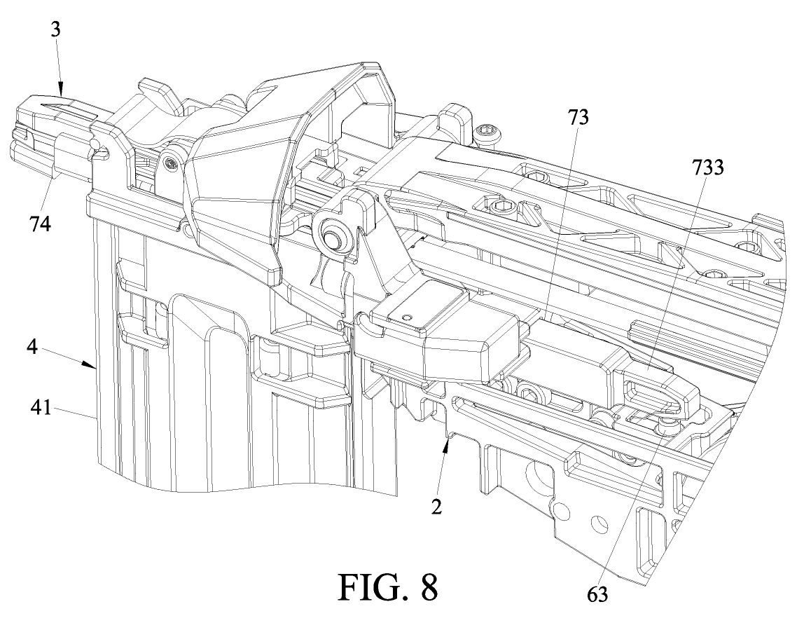

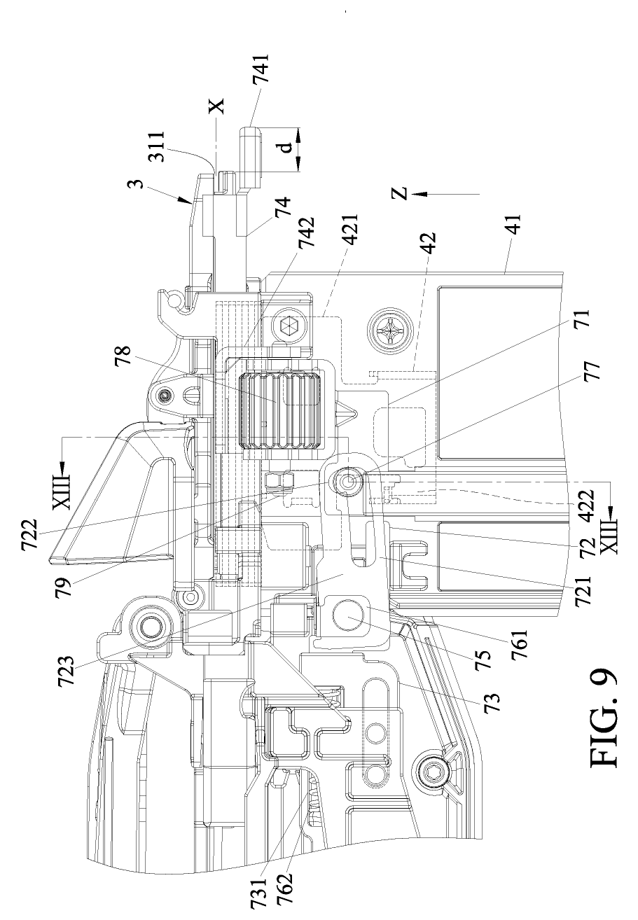

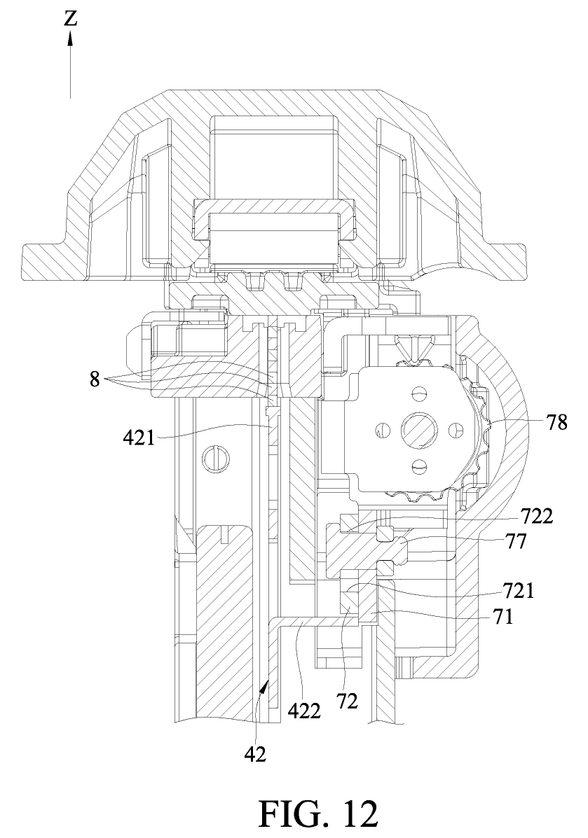

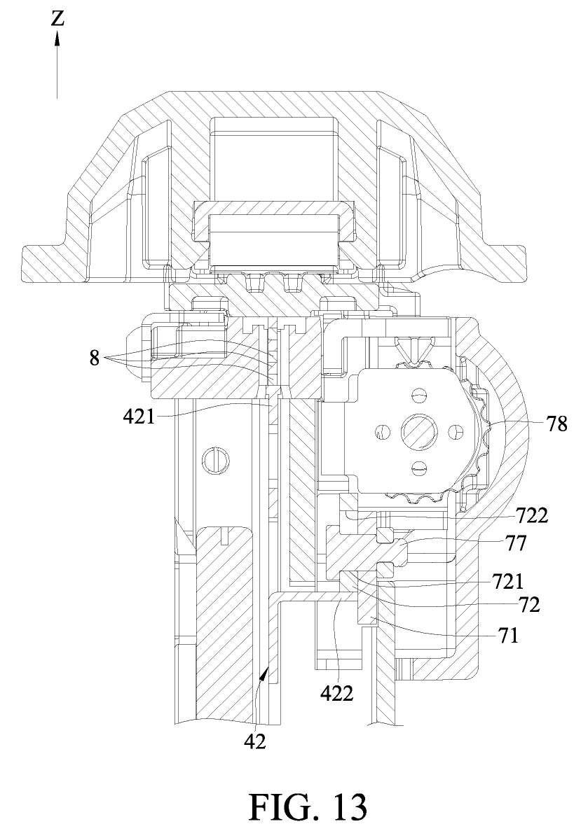

The second safety member 72 is movable between a linked position (see FIGS. 5, 7, and 12),, where the second safety member 72 is spaced apart from the protrusion 422 of the magazine pusher 42 in the feeding direction (Z), is co-movable with the first safety member 71, and triggers the safety switch 63 when being moved toward the safety switch 63 (see FIG. 8), and a delinked position (see FIGS. 9, 10 and 13 ), where the second safety member 72 is pushed by the protrusion 422 and is movable relative to the first safety member 71 along the axis (X) such that movement of the first safety member 71 does not move the second safety member 72. Specifically, when the second safety member 72 is biased by the first biasing member 761 to pivot about the connecting pin 75 in the direction opposite to the feeding direction (Z) to the linked position, i.e., away from the muzzle unit 3, the slidable pin 77 engages the engaging slot 722 and is immovable relative to the second safety member 72 along the axis (X) as limited by the main body 723, such that the second safety member 72 is co-movable with the first safety member 71.

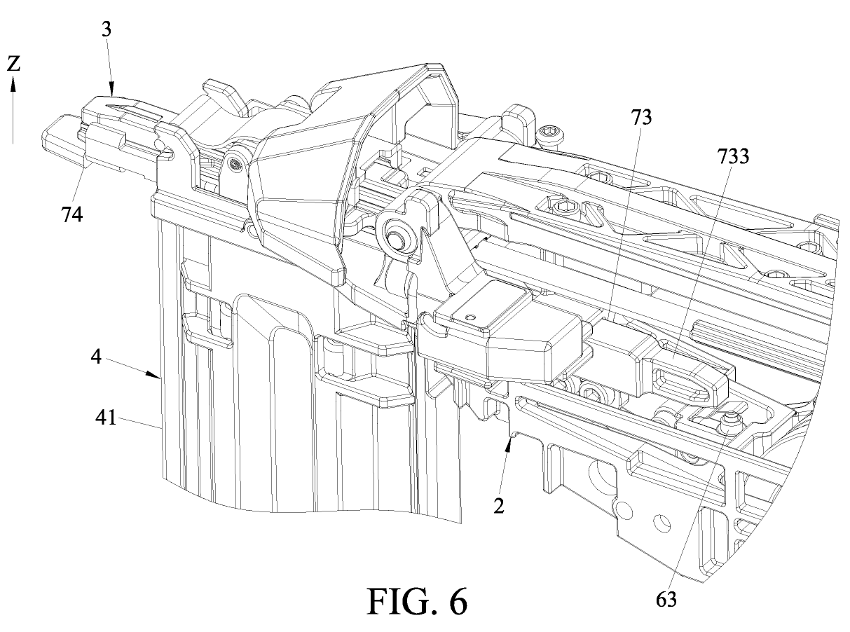

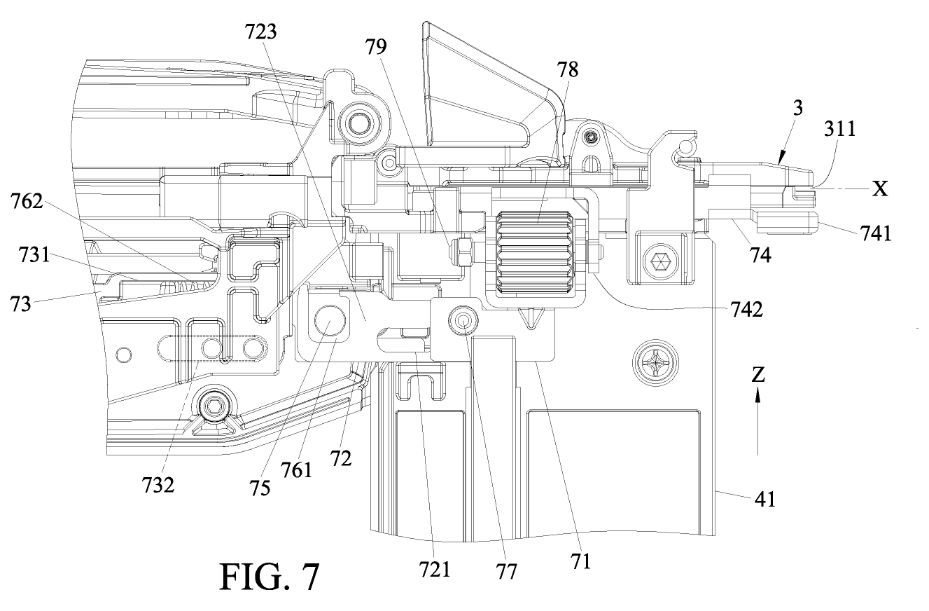

Generally, when no external force is exerted on the electric nail gun, as shown in FIGS. 3 and 5, the third safety member 73 is biased by the second biasing member 762 to move away from the safety switch 63 (see FIG. 6), the first safety member 71 is biased by the third biasing member 763 (see FIG. 3) to move away from the gun body 2, and the abutment end 741 of the fourth safety member 74 extends away from and is spaced apart from the nail discharge opening 311 of the nail-striking channel 31 by the distance (d). Referring to FIG. 7, when the abutment end 741 of the fourth safety member 74 is pressed onto an object (not shown), the abutment end 741 is flush with the nail discharge opening 311, the gun body 2 moves along the axis (X) toward the object to counteract a biasing force of the third biasing member 763 exerted on the first safety member 71 and a biasing force of the second biasing member 762 exerted on the third safety member 73, and the safety switch 63 also moves along the axis (X) towards the third safety member 73. As shown in FIG. 8, the safety switch 63 is triggered to output the safety signal when being pushed by the extension segment 733 of the third safety member 73. Hereafter, when the trigger 62 is operated, e.g., pulled, the trigger switch 61 is triggered to output the start signal and thus the controller 64 initiates the striking cycle upon receipt of both of the start signal and the safety signal to perform a nail-striking operation. At this time, the pivot arm 53 is driven to pivot so the distance between the pivot arm 53 and the flywheel 51 is reduced, and the impact block 54 comes into contact with the flywheel 51 to drive the nail-striking pin 55 to strike the nails 8 in the nail-striking channel 31. It should be noted that since the main feature of the present disclosure of the present application does not reside in how the nails 8 are struck, further details of the same are omitted for the sake of brevity.

When the nails 8 arranged in a row are brought to be accommodated in the nail magazine 41, the magazine pusher 42 is pushed away from the muzzle unit 3 by the nails 8. In this embodiment, the magazine pusher 42 is biased toward the muzzle unit 3 in the feeding direction (Z) by a biasing member (not shown), so the nails 8 are pushed thereby toward the nail-striking channel 31. In this way, the protrusion 422 of the magazine pusher 42 gradually moves toward the second safety member 72 when the nails 8 in the nail magazine 41 are sequentially struck out of the nail discharge opening 311. When the number of the nails 8 in the nail magazine 41 falls below a predetermined number, the second safety member 72 is switched from the linked position (see FIGS. 5, 7 and 12) to the delinked position (see FIGS. 9, 10 and 13). Specifically, the second safety member 72 is pushed by the protrusion 422 of the magazine pusher 42, and pivots about the connecting pin 75 substantially in the feeding direction (Z), i.e., toward the muzzle unit 3, such that the slidable pin 77 disengages the engaging slot 722, engages the sliding slot 721, and is slidable along the sliding slot 721. In this way, the first safety member 71 is movable relative to the second safety member 72 along the axis (X).

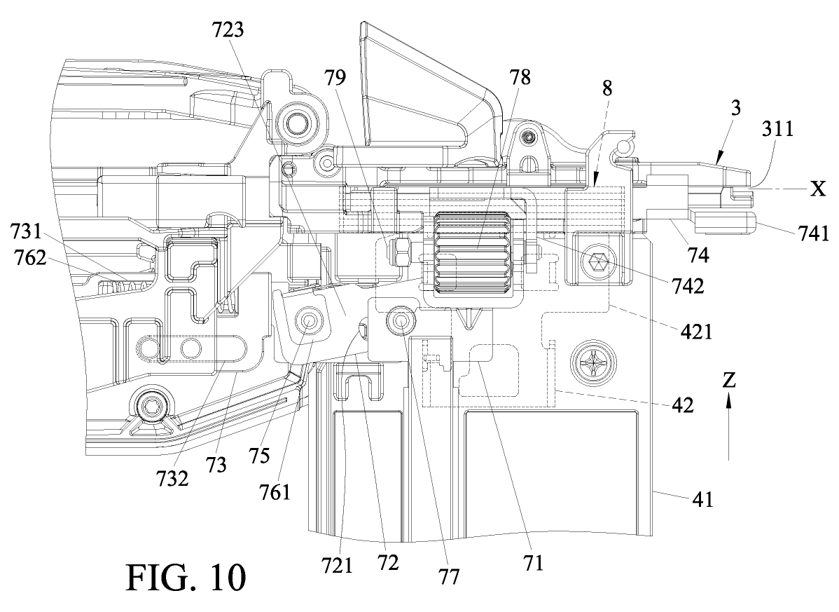

As shown in FIG. 9, when the second safety member 72 is in the delinked position and no external force is exerted on the electric nail gun, the third safety member 73 is biased by the second biasing member 762 to move away from the safety switch 63, the first safety member 71 is biased by the third biasing member 763 (see FIG. 3) to move away the gun body 2, and the abutment end 741 of the fourth safety member 74 extends away from and is spaced apart from the nail discharge opening 311 of the nail-striking channel 31 by the distance (d). Referring to FIG. 10, when the abutment end 741 of the fourth safety member 74 is pressed onto an object (not shown), the abutment end 741 is flush with the nail discharge opening 311, the gun body 2 moves toward the object to counteract the biasing force of the third biasing member 763 exerted on the first safety member 71 and the biasing force of the second biasing member 762 exerted on the third safety member 73, and the safety switch 63 moves toward the third safety member 73. By virtue of engagement between the sliding slot 721 and the slidable pin 77 that guides the second safety member 72 to move relative to the first safety member 71 along the axis (X) toward the fourth safety member 74, the third safety member 73 also moves toward the fourth safety member 74. In this way, the safety switch 63 is still spaced apart from the third safety member 73 at this position, is not pushed by the extension segment 733, and does not output the safety signal. At this position, even if the trigger 62 is pulled to trigger the trigger switch 61, the controller 64 does not initiate the striking cycle as a result of not receiving the safety signal, thereby achieving the purpose of not striking nails 8 when the number of the nails 8 falls below the predetermined number.

It should be noted that, under the premise that the protrusion 422 is able to push the second safety member 72 to the delinked position, an original position of the protrusion 422 in the nail magazine 41 in the feeding direction (Z) when the nail magazine 41 is empty may be adjusted as required. Such an adjustment changes a distance between the protrusion 422 and the muzzle unit 3 in the feeding direction (Z) so the predetermined number of the nails 8 may be adjusted. As shown in FIGS. 9, 10 and 13, in this embodiment, the number of the nails 8 is seven, but the present disclosure is not limited herein. Thus, when the number of the nails 8 in the nail magazine 41 falls below seven, the protrusion 422 of the magazine pusher 42 pushes the second safety member 72 to the delinked position to disable the nail-striking operation. When the original position of the protrusion 422 in the feeding direction (Z) is adjusted to be closer to the muzzle unit 3, the predetermined number of the nails 8 is reduced, and vice versa.

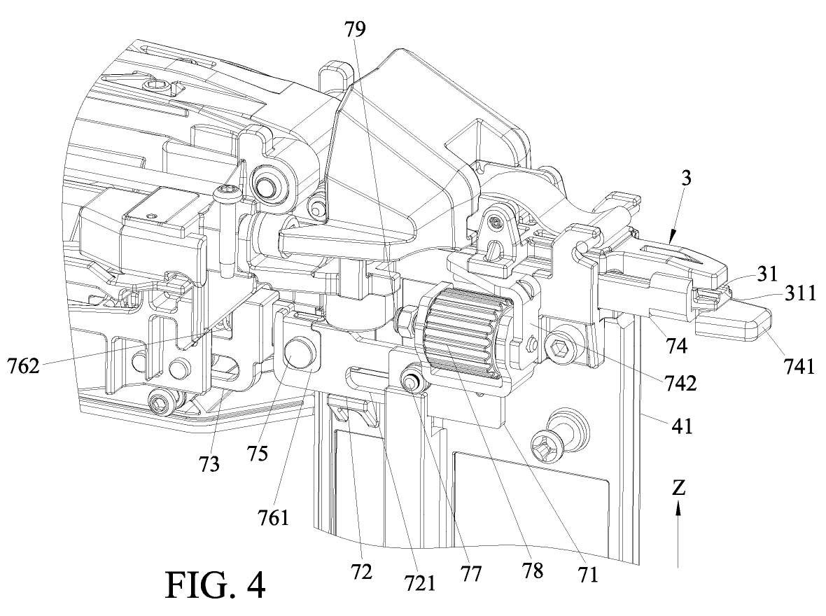

Additionally, referring to FIGS. 4 and 5, when the adjusting member 78 is rotated, threaded engagement between the adjusting member 78 and the connector 79 drives movement of the connector 79 and the fourth safety member 74 along the axis (X) relative to the first safety member 71, such that the distance (d) between the abutment end 741 and the nail discharge opening 311 is adjusted. By doing so, a nail striking depth of the nails 8 may be adjusted.

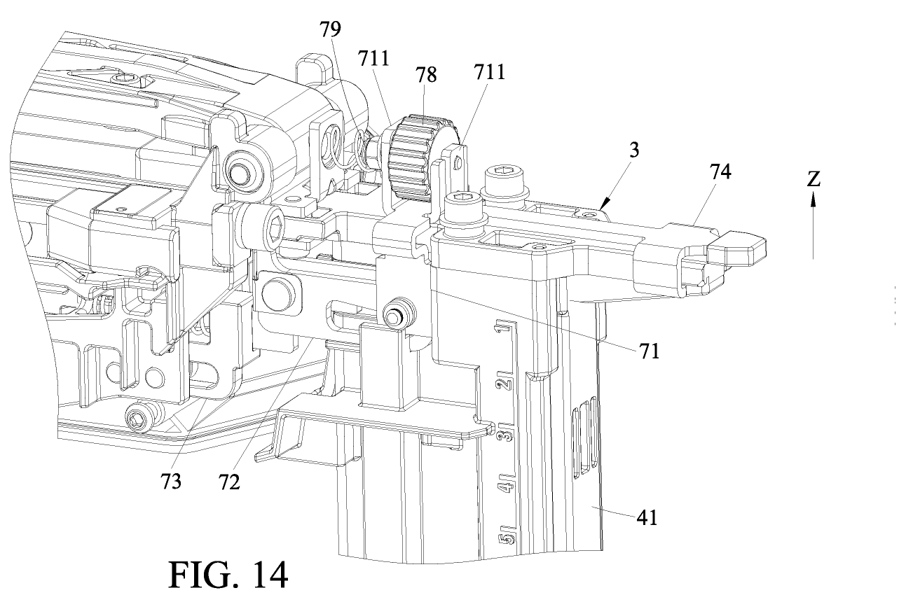

Referring to FIG. 14, the electric nail gun of a second embodiment according to the present disclosure is shown. The second embodiment is similar to the first embodiment and the differences therebetween reside in the following. In the second embodiment, the fourth safety member 74 is mounted to the nail magazine 41 with the abutment end 741 disposed over the nail discharge opening 311 in the feeding direction (Z), i.e., the fourth safety member 74 is mounted up-side down as compared to the first embodiment. Furthermore, the lugs 711 of the first safety member 71 extend away from the nail magazine 41 in the feeding direction (Z) beyond the muzzle unit 3. In this embodiment, the first safety member 71 is generally L-shaped, and the lugs 711, the adjusting member 78, and the connector 79 are disposed above the muzzle unit 3 in the feeding direction (Z).

The advantages and effects of the embodiments according to the present disclosure are summarized below.

1. By virtue of the trigger switch 61 and the safety switch 63, the controller 64 initiates the striking cycle only when both of the trigger switch 61 and the safety switch 63 are triggered, thereby providing a safety mechanism that enhances the overall safety of use.

2. Moreover, by virtue of cooperation of the safety switch 63 and the safety unit 7, when the number of the nails 8 in the nail magazine 41 falls below the predetermined number, even if the trigger 62 is pulled, the controller 64 does not initiate the striking cycle and the nails 8 will not be struck, thereby achieving the purpose of preventing nail striking when the numbers of the nail 8 is low. In this way, the electric nail gun has relatively high reliability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric nail gun, comprising:
a gun body;
a muzzle unit that is connected to said gun body, and that defines a nail-striking channel extending along an axis;
a magazine unit that is connected to the muzzle unit, and that includes a nail magazine adapted for accommodating a plurality of nails arranged in a row, and a magazine pusher movably mounted in said nail magazine, adapted for pushing the plurality of nails sequentially into said nail-striking channel, and including a protrusion;
a power unit that is mounted to said gun body and that is adapted to strike the plurality of nails in said nail-striking channel during a striking cycle;
a control unit that is mounted to said gun body, and that includes a trigger switch configured to output a start signal when being triggered, a trigger operable to trigger said trigger switch, a safety switch configured to output a safety signal when being triggered, and a controller electrically connected to said trigger switch and said safety switch, and configured to initiate the striking cycle upon receipt of the start signal and the safety signal; and
a safety unit that is movably mounted between said gun body and said muzzle unit along the axis, and that includes a first safety member movable along the axis, and a second safety member disposed between said safety switch and said first safety member along the axis, and movable between a linked position, where said second safety member is spaced apart from said protrusion of said magazine pusher, is co-movable with said first safety member, and triggers said safety switch when being moved toward said safety switch, and a delinked position, where said second safety member is pushed by said protrusion and is movable relative to said first safety member along the axis such that movement of said first safety member does not move said second safety member.

2. The electric nail gun as claimed in claim 1, wherein:
said power unit is adapted to strike the plurality of nails in said nail-striking channel along the axis; and
said magazine pusher is adapted for pushing the plurality of nails one by one into said nail-striking channel in a feeding direction perpendicular to the axis.

3. The electric nail gun as claimed in claim 2, wherein:
said safety unit further includes a slidable pin connected fixedly to said first safety member and extending through said second safety member,
said second safety member has a main body defining a sliding slot that extends along the axis and an engaging slot that is in spatial communication with said sliding slot, and that extends from one end of said sliding slot along the feeding direction;
when said second safety member is in the linked position, said slidable pin engages said engaging slot and is immovable relative to said second safety member along the axis as limited by said main body of said second safety member such that said second safety member is co-movable with said first safety member; and
when said second safety member is in the delinked position, said slidable pin engages and is movable along said sliding slot.

4. The electric nail gun as claimed in claim 1, wherein:
said safety unit further includes a third safety member disposed between said second safety member and said safety switch along the axis; and
when said second safety member is in the linked position and is moved toward the safety switch, said third safety member is driven by said second safety member to move toward said safety switch to trigger said safety switch.

5. The electric nail gun as claimed in claim 4, wherein:
said safety unit further includes a biasing member;
said third safety member has a groove extending along the axis and slidably engaging said gun body; and
said biasing member is disposed in said groove, has two opposite ends abutting respectively against said gun body and said third safety member, and biases said third safety member away from said safety switch along the axis.

6. The electric nail gun as claimed in claim 5, wherein:
said third safety member has an extension segment extending towards said safety switch along the axis and triggering said safety switch to output the start signal when said second safety member is moved toward said safety switch.

7. The electric nail gun as claimed in claim 4, wherein:
said safety unit further includes a connecting pin and a biasing member;
said connecting pin is pivotably connected to said second safety member and said third safety member such that said second safety member is pivotable about said connecting pin relative to said third safety member; and
said biasing member is mounted above said second safety member in a feeding direction perpendicular to the axis, and biases said second safety member to the linked position.

8. The electric nail gun as claimed in claim 1, wherein:
said power unit includes a flywheel rotatably mounted to said gun body, a pivot arm connected to said gun body and pivotable relative to said flywheel, an impact block slidable along said pivot arm, and a nail-striking pin connected to said impact block and extending into said nail-striking channel; and
when a distance between said flywheel and said pivot arm is reduced, said impact block is in contact with and is actuated by said flywheel to drive said nail-striking pin to strike the nails in said nail-striking channel.

9. The electric nail gun as claimed in claim 1, wherein:
said nail-striking channel has a nail discharge opening disposed opposite to said gun body along the axis;
said safety unit further includes a fourth safety member, an adjusting member, and a connector;
said fourth safety member is mounted to said muzzle unit, is movable relative to said muzzle unit along the axis, and has an abutment end extending away from and spaced apart from said nail discharge opening along the axis by a distance, and a connecting plate opposite to said abutment end along the axis and connected fixedly to said connector;
said adjusting member is rotatably mounted in said first safety member;
said connector extends into said first safety member, and threadedly engages said adjusting member; and
when said adjusting member is rotated, said connector is co-movable with said fourth safety member relative to said first safety member along the axis such that the distance between said nail discharge opening and said abutment end is adjusted.

10. The electric nail gun as claimed in claim 9, wherein said safety unit further includes a biasing member mounted between said fourth safety member and said gun body and biasing said first safety member away from said gun body along the axis.
